(19) United States
(12) Patent Application Publication
(10) Pub. No.: US 2025/0381653 A1
(43) Pub. Date: Dec. 18, 2025

(54) REMOVAL TOOL AND METHOD FOR SERVICEABLE PROPELLER SHAFT ZERO AIR GAP SEAL

(71) Applicant: Pratt & Whitney Canada Corp., Longueuil (CA)

(72) Inventors: Eric S. Durocher, Boucherville (CA); Herve Turcotte, Ste-Julie (CA)

(21) Appl. No.: 18/743,699

(22) Filed: Jun. 14, 2024

(51) Int. Cl. B25B 27/00

(52) U.S. Cl. CPC B25B 27/0028

(57) ABSTRACT

A removal tool assembly for a shaft bearing seal including a rotating inner seal element and a stationary outer seal includes a first tool portion configured to radially move the outer seal radially outwardly to create a radial gap between the outer seal and the inner seal element disposed at a shaft, and a second tool portion operably connected to the first tool portion. The second tool portion is configured to axially remove the outer seal from a bearing housing while the inner seal element remains in the bearing housing.

### BACKGROUND

Exemplary embodiments pertain to the art of propeller shaft and bearing systems, and the sealing thereof.

In propeller-driven aircraft systems, the propeller is located on a propeller shaft, which is rotatable about a shaft axis. The propeller shaft is supported by one or more bearings, and seals are installed to prevent leakage of lubricant from the bearing. These seals however, tend to wear in operation and leak oil from the bearing which is unacceptable to customers and also creates environmental issues. The art would welcome better performing and serviceable sealing solutions for the propeller shaft and the associated bearing.

### BRIEF DESCRIPTION

In one exemplary embodiment, a removal tool assembly for a shaft bearing seal including a rotating inner seal element and a stationary outer seal includes a first tool portion configured to radially move the outer seal radially outwardly to create a radial gap between the outer seal and the inner seal element disposed at a shaft, and a second tool portion operably connected to the first tool portion. The second tool portion is configured to axially remove the outer seal from a bearing housing while the inner seal element remains in the bearing housing.

Additionally or alternatively, in this or other embodiments the first tool portion includes a seal holder engageable with a radially inner surface of the outer seal, a radial reaction puller engaged to the bearing housing, a threaded holder rod extending between the seal holder and the radial reaction puller, and a radial pulling nut installed onto the holder rod such that tightening the radial pulling nut onto the holder rod pulls the seal holder and the outer seal radially outwardly, thus creating the radial gap between the outer seal and the inner seal element.

Additionally or alternatively, in this or other embodiments a plurality of seal holders and a plurality of radial reaction pullers are arrayed around a shaft axis of the shaft.

Additionally or alternatively, in this or other embodiments the radial reaction puller is positioned radially outboard of the seal holder.

Additionally or alternatively, in this or other embodiments the radial reaction puller engages a radially outer surface of the bearing housing.

Additionally or alternatively, in this or other embodiments the second tool portion includes an axial flange of the radial reaction puller engaged with the outer seal, a tool plate installed to a shaft end of the shaft, and a puller bolt extending through the tool plate and engaged to the radial reaction puller. Tightening the puller bolt against the tool plate generates an axial pulling load on the radial reaction puller, resulting in the retraction of the outer seal from the bearing housing.

Additionally or alternatively, in this or other embodiments one or more locating pins in the tool plate are configured to be installed into corresponding one or more alignment openings in the shaft end for radial and circumferential alignment of the tool plate relative to the radial reaction puller.

Additionally or alternatively, in this or other embodiments the axial flange in configured to engage with a locating tab of the outer seal.

Additionally or alternatively, in this or other embodiments the puller bolt is installed into a corresponding threaded puller bolt opening in the radial reaction puller.

In another exemplary embodiment, a removal tool system for a shaft bearing seal including a rotating inner seal element fixed to a rotating shaft and a stationary outer seal fixed to a bearing housing includes a plurality of seal holders arrayed about a shaft axis of the shaft and configured for engagement with a radially inner surface of the outer seal. A plurality of radial reaction pullers are engaged to the bearing housing. A plurality of threaded holder rods each extend between a seal holder of the plurality of seal holders and a corresponding the radial reaction puller of the plurality of radial reaction puller. A plurality of radial pulling nuts are installed onto the plurality of holder rods such that tightening the radial pulling nuts onto the holder rods pulls the plurality of seal holders and the outer seal radially outwardly, thus creating a radial gap between the outer seal and the inner seal element. An axial flange of each radial reaction puller of the plurality of radial reaction pullers are configured for engagement with the outer seal. A tool plate is installed to a shaft end of the shaft, and a plurality of puller bolts extending through the tool plate and engaged to corresponding radial reaction pullers of the plurality of radial reaction pullers. Tightening the plurality of puller bolts against the tool plate generates an axial pulling load on the plurality of radial reaction pullers, resulting in the retraction of the outer seal from the bearing housing.

Additionally or alternatively, in this or other embodiments one or more locating pins are positioned in the tool plate and are configured to be installed into corresponding one or more alignment openings in the shaft end for radial and circumferential alignment of the tool plate relative to the radial reaction puller.

Additionally or alternatively, in this or other embodiments the axial flange in configured to engage with a locating tab of the outer seal.

Additionally or alternatively, in this or other embodiments the puller bolt is installed into a corresponding threaded puller bolt opening in the radial reaction puller.

Additionally or alternatively, in this or other embodiments the shaft is a propeller shaft of a propeller assembly.

In yet another exemplary embodiment, a method of disassembling a shaft bearing seal assembly including a rotating inner seal element fixed to a rotating shaft and a stationary outer seal fixed to a bearing housing, includes operating a first tool portion, thereby radially moving the outer seal radially outwardly to create a radial gap between the outer seal and the inner seal element, operating a second tool portion operably connected to the first tool portion after operating the first tool portion. The operating of the second tool portion thereby axially removes the outer seal from a bearing housing while the inner seal element remains in the bearing housing.

Additionally or alternatively, in this or other embodiments operating the first tool portion includes installing a seal holder to engage with a radially inner surface of the outer seal, installing a radial reaction puller to engage with the bearing housing, connecting the seal holder to the radial reaction puller via a threaded holder rod extending between the seal holder and the radial reaction puller, and tightening a radial pulling nut onto the holder rod such that tightening the radial pulling nut onto the holder rod pulls the seal holder and the outer seal radially outwardly, thus creating the radial gap between the outer seal and the inner seal element.

Additionally or alternatively, in this or other embodiments operating the second tool portion includes engaging an axial flange of the radial reaction puller engaged with the outer seal, installing a tool plate to a shaft end of the shaft, connecting the tool plate to the radial reaction puller via a puller bolt extending through the tool plate and into the radial reaction puller, and tightening the puller bolt against the tool plate, thereby generating an axial pulling load on the radial reaction puller to retract of the outer seal from the bearing housing.

Additionally or alternatively, in this or other embodiments the method includes installing one or more locating pins of the tool plate configured into corresponding one or more alignment openings in the shaft end to align the tool plate relative to the shaft end.

Additionally or alternatively, in this or other embodiments the axial flange in configured to engage with a locating tab of the outer seal.

Additionally or alternatively, in this or other embodiments the puller bolt is installed into a corresponding threaded puller bolt opening in the radial reaction puller.

### BRIEF DESCRIPTION OF THE DRAWINGS

The following descriptions should not be considered limiting in any way. With reference to the accompanying drawings, like elements are numbered alike:

FIG. 1 is a schematic illustration of an embodiment of a propeller system;

FIG. 2 is a schematic illustration of a bearing arrangement for a propeller shaft;

FIG. 3 is a cross-sectional view of an embodiment of a bearing seal assembly of a propeller shaft;

FIG. 4 is a cross-sectional view of and embodiment of a bearing seal assembly illustrated an after-operation condition;

FIG. 5 is a cross-sectional view of a first removal tool portion installed to the seal assembly;

FIG. 6 is another cross-sectional view of a first removal tool portion installed to the seal assembly;

FIG. 7 is a perspective illustration of a first removal tool portion installed to the seal assembly;

FIG. 8 is a cross-sectional view of a second removal tool portion installed to the seal assembly;

FIG. 9 is a perspective view of a second removal tool portion installed to the seal assembly;

FIG. 10 is a cross-sectional view illustrating operation of the removal tool; and

FIG. 11 is a perspective view illustrating operation of the removal tool.

### DETAILED DESCRIPTION

A detailed description of one or more embodiments of the disclosed apparatus and method are presented herein by way of exemplification and not limitation with reference to the Figures.

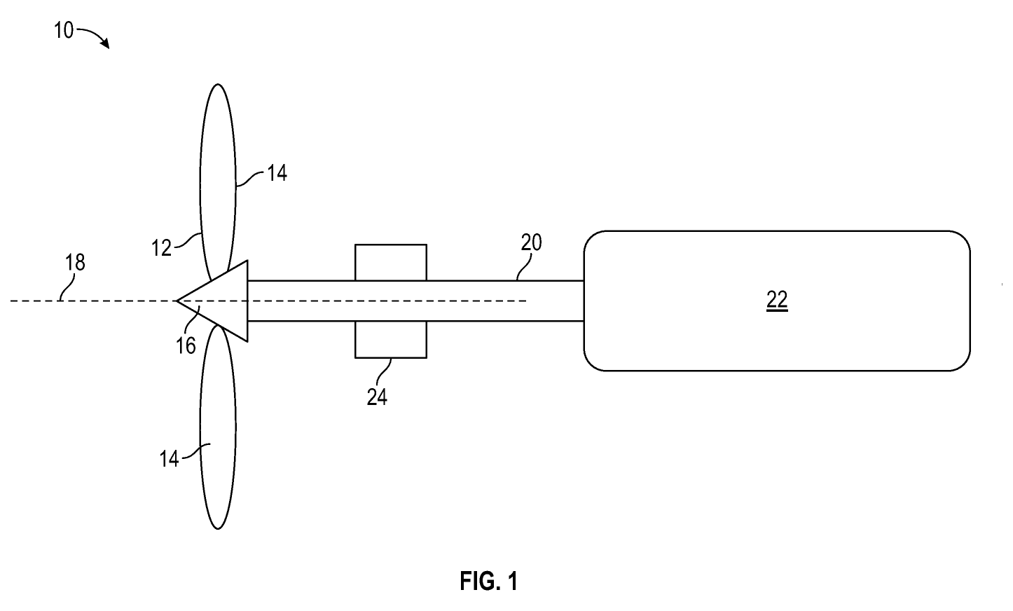

Referring now to FIG. 1, an embodiment of a propeller system 10 of an aircraft is illustrated. The propeller system 10 includes a propeller 12 having a plurality of blades 14 extending radially from a propeller hub 16. The propeller 12 is driven to rotate about a propeller axis 18 by a propeller shaft 20 to which the propeller 12 is secured. The propeller shaft 20 is driven to rotate about the propeller axis 18 by an engine 22 operably connected to the propeller shaft 20. Additionally, the propeller shaft 20 is supported at the propeller axis 18 by a bearing system 24.

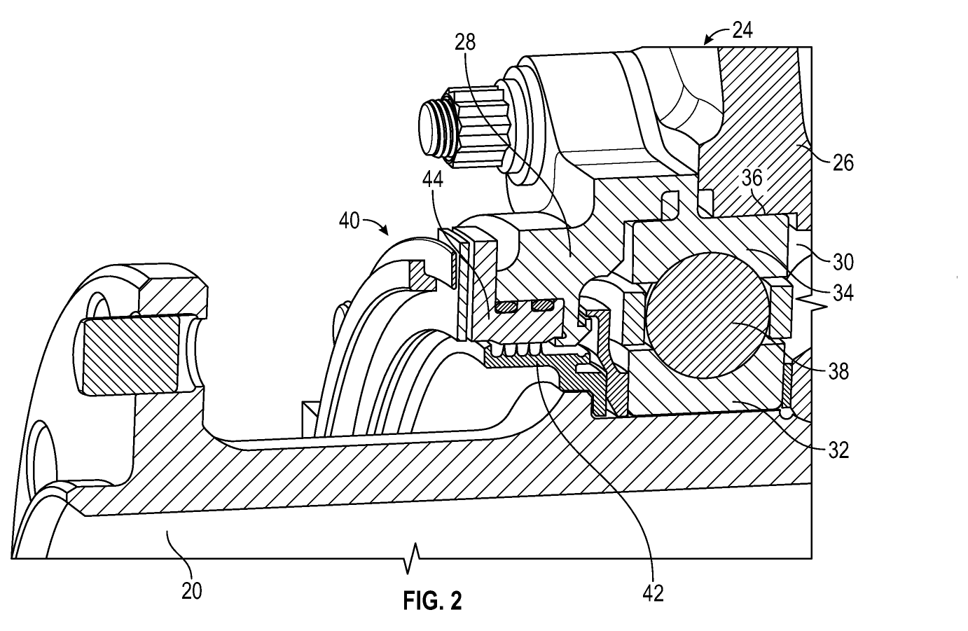

Referring now to FIG. 2, the bearing system 24 includes a housing 26 and a cover plate 28, which together define a bearing enclosure 30. A bearing inner race 32 is disposed at the propeller shaft 20 and rotates about the propeller axis 18 with the propeller shaft 20 and a bearing outer race 34 is disposed at an inner surface 36 of the bearing enclosure 30. A plurality of bearing elements 38 are located radially between the bearing inner race 32 and the bearing outer race 34.

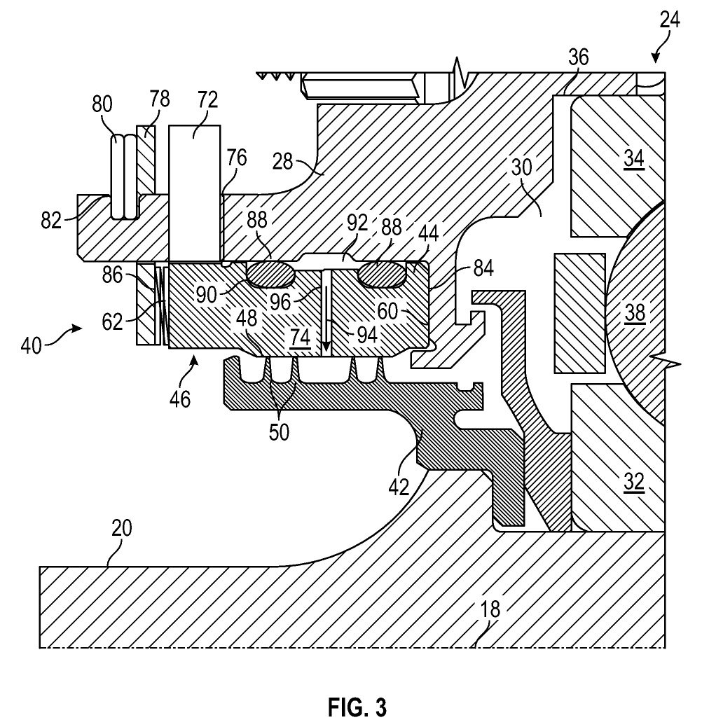

Referring to FIG. 3, a seal assembly 40 is installed to the bearing system 24 to prevent egress of bearing lubricant from the bearing enclosure 30 and to prevent ingress of air, dirt, or other contaminants into the bearing enclosure 30. The seal assembly includes a rotating inner seal element 42 installed to the propeller shaft 20 and rotatable about the propeller axis 18 therewith. Additionally, a rotationally fixed outer seal 44 is installed to the inner surface 36, in some embodiments to the cover plate 28. A seal interface 46 is defined between a radially inner surface 48 of the outer seal 44, and the inner seal element 42. In some embodiments, the inner seal element 42 is configured with a plurality of knife edges 50 that define the seal interface 46 with the radially inner surface 48. Additionally, in some embodiments the radially inner surface 48 is formed from an abradable material into which the plurality of knife edges 50 rub during operation.

Referring again to FIG. 3, the outer seal 44 is circumferentially located in the cover plate 28 via a plurality of locating tabs 72 extending radially outwardly from a seal body 74 of each of the first seal segment 52 and the second seal segment 54. The locating tabs 72 are positioned into corresponding locating notches 76 defined in the cover plate 28. A retaining ring 78 is installed axially onto the seal body 74 and the locating tabs 72, and one or more key washers 80 are installed over the retaining ring 78 in a key washer opening 82 in the cover plate 28 to axially retain the outer seal 44 in the cover plate 28. In some embodiments, the outer seal 44 is axially loaded against a seal stop 84 of the housing 26 via a Belvil type washer 86 disposed between the outer seal 44 and the retaining ring 78.

O-rings 88 are installed at an outer seal surface 90 of the outer seal 44, between the outer seal 44 and the inner surface 36, defining an outer cavity 92. In some embodiments airflow 94 is injected into the outer cavity 92 via an air passage 96 in the outer seal 44 to pressurize the outer cavity 92 and urge the outer seal 44 radially inwardly toward the inner seal element 42, which improves the sealing therebetween.

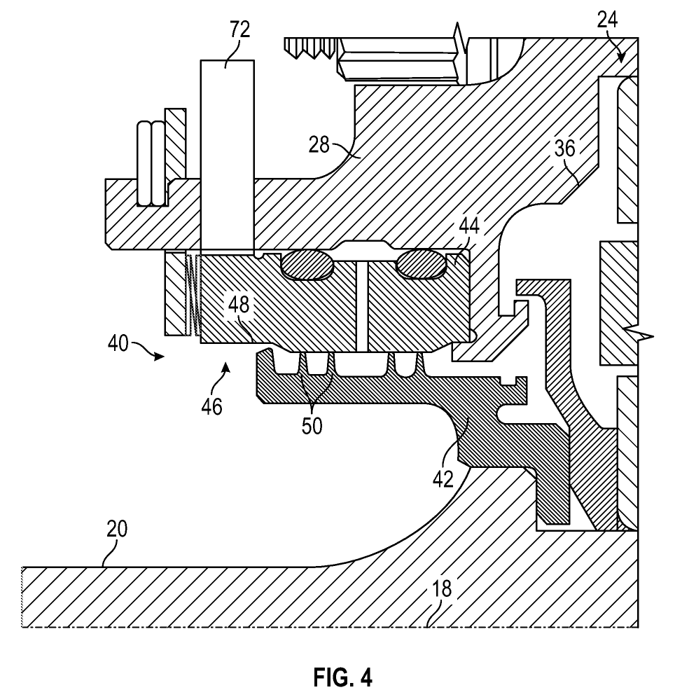

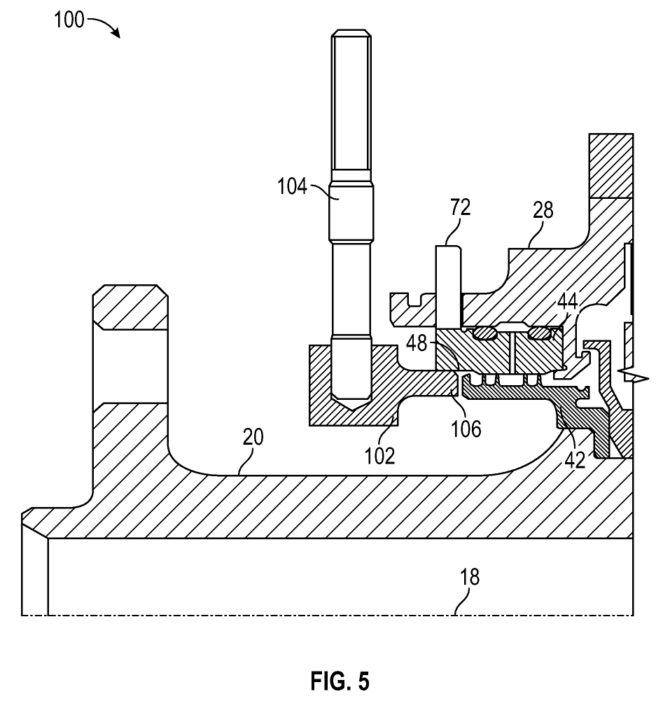

Referring now to FIG. 4, after operation of the propeller system 10 the knife edges 50 of the inner seal element 42 rubs into the outer seal 44 creating a radial interference between the inner seal element 42 and the outer seal 44. To remove the outer seal 44 for service a tool assembly 100, as will be described below with reference to FIGS. 5-11, is utilized to remove the outer seal 44 from the propeller system 10.

Referring first to FIG. 5, tool assembly 100 includes one or more seal holders 102 and holder rods 104 extending perpendicularly from each of the seal holders 102. The seal holder 102 includes a holder flange 106 that is positioned at the radially inner surface 48 of the outer seal 44, such that the holder flange 106 is radially inboard of the radially inner surface 48. When the seal holder 102 is installed, the holder rod 104 extends radially outwardly from the seal holder 102. In some embodiments, multiple seal holders 102 and corresponding holder rods 104 are arrayed about the shaft axis 18.

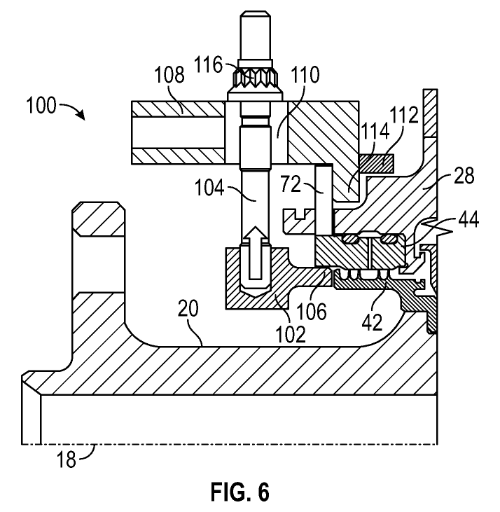

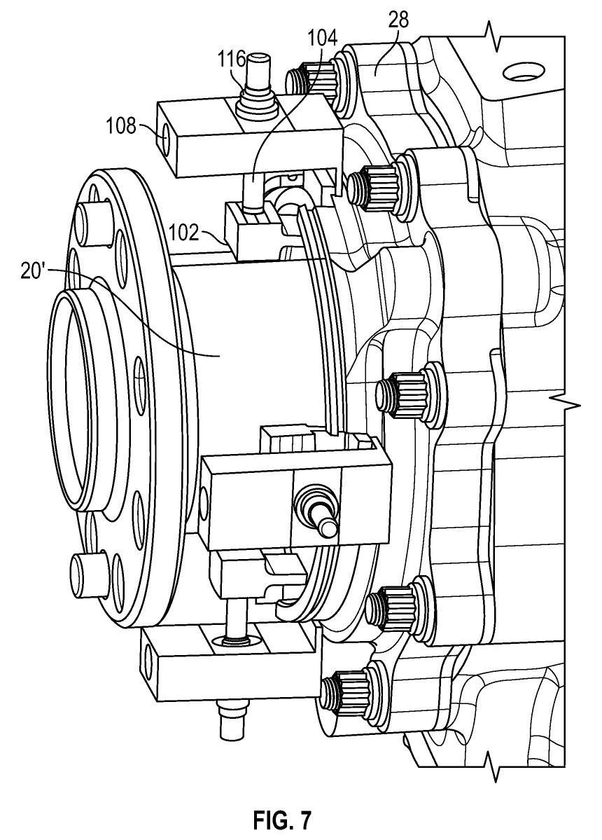

Referring now to FIGS. 6 and 7, one or more radial reaction pullers 108 is installed onto the cover plate 28 and includes a puller opening 110 through which the holder rod 104 extends. In some embodiments, a plurality of radial reaction pullers 108 are spaced around the shaft axis 18. Each of the radial reaction pullers 108 includes a radial flange 112 engaged with the cover plate 28, and an axial flange 114 engaged with a locating tab 72 of the outer seal 44. A radial pulling nut 116 is installed onto the threaded holder rod 104, and as tightened pulls seal holder 102 radially outwardly, which in turn pulls the outer seal 44 radially outwardly relieving any interference fit and leaving a radial gap between the outer seal 44 and the inner seal element 42.

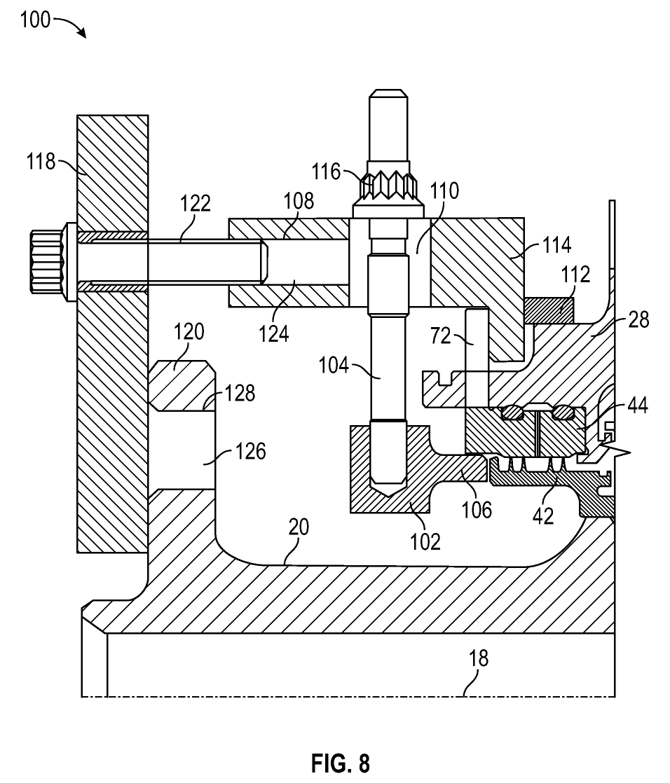

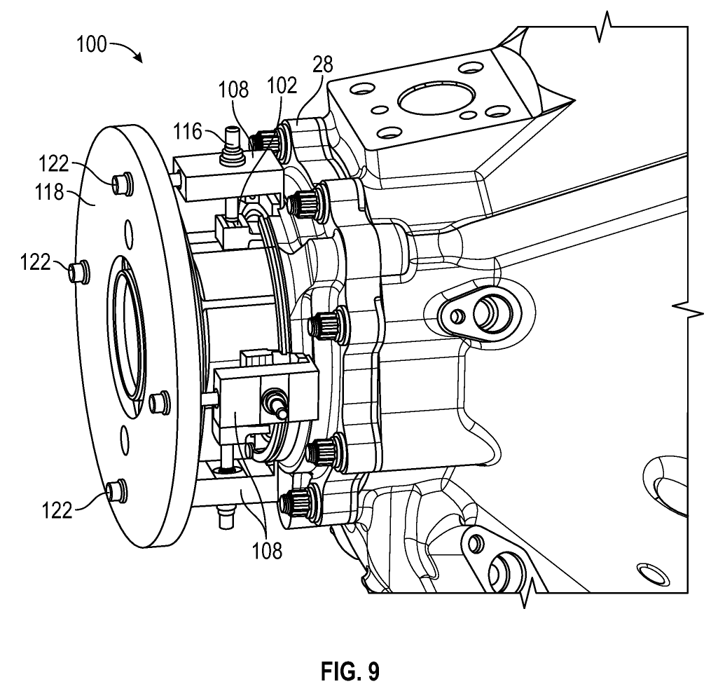

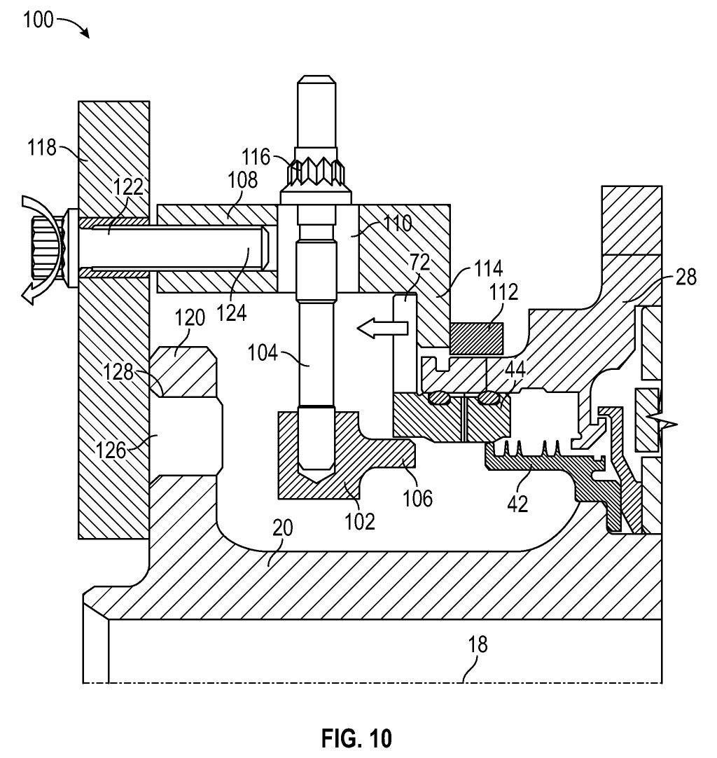

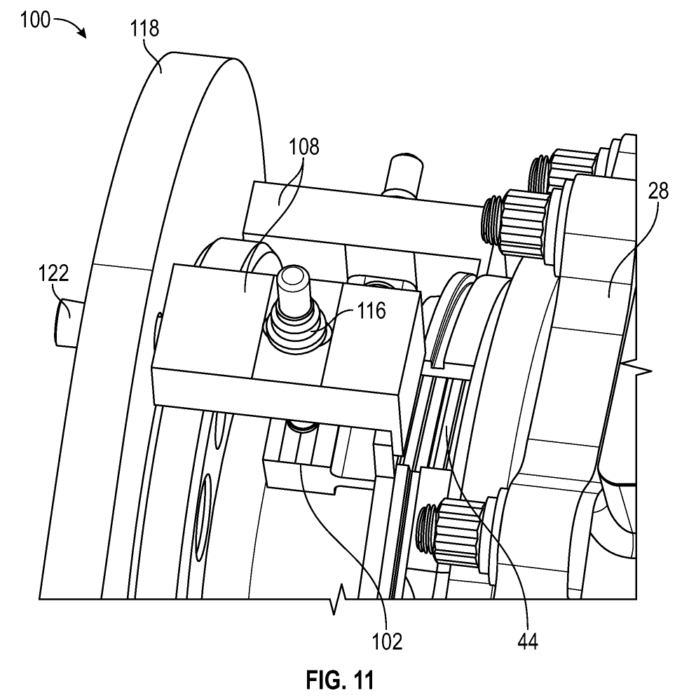

As illustrated now in FIGS. 8 and 9, a tool plate 118 is installed to a shaft end 120 of the propeller shaft 20 and connected to the radial reaction pullers 108 via puller bolts 122. The puller bolts 122 are installed into corresponding threaded puller openings 124 in the radial reaction pullers 108. The tool plate 118 may be located at the shaft end 120 via one or more alignment pins 126 of the tool plate 118 installed into corresponding alignment openings 128 in the shaft end 120. As best illustrated in FIGS. 10 and 11, as the puller bolts 122 are tightened against the tool plate 118, a pulling load is generated on the radial reaction pullers 108, resulting in the retraction of the outer seal 44 from the cover plate 28.

The present disclosure describes a tool assembly 100 and method to provide for efficient disassembly of the seal assembly by first eliminating radial interference of the outer seal 44 and the inner seal element 42, then axially removing the outer seal 44 from the cover plate 28.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A removal tool assembly for a shaft bearing seal including a rotating inner seal element and a stationary outer seal, the removal tool assembly including:
a first tool portion configured to radially move the outer seal radially outwardly to create a radial gap between the outer seal and the inner seal element disposed at a shaft; and
a second tool portion operably connected to the first tool portion, the second tool portion configured to axially remove the outer seal from a bearing housing while the inner seal element remains in the bearing housing.

2. The removal tool assembly of claim 1, wherein the first tool portion includes:
a seal holder engageable with a radially inner surface of the outer seal;
a radial reaction puller engaged to the bearing housing;
a threaded holder rod extending between the seal holder and the radial reaction puller; and
a radial pulling nut installed onto the holder rod such that tightening the radial pulling nut onto the holder rod pulls the seal holder and the outer seal radially outwardly, thus creating the radial gap between the outer seal and the inner seal element.

3. The removal tool assembly of claim 2, further comprising a plurality of seal holders and a plurality of radial reaction pullers arrayed around a shaft axis of the shaft.

4. The removal tool assembly of claim 2, wherein the radial reaction puller is disposed radially outboard of the seal holder.

5. The removal tool assembly of claim 2, wherein the radial reaction puller engages a radially outer surface of the bearing housing.

6. The removal tool assembly of claim 2, wherein the second tool portion includes:
an axial flange of the radial reaction puller engaged with the outer seal;
a tool plate installed to a shaft end of the shaft; and
a puller bolt extending through the tool plate and engaged to the radial reaction puller;
wherein tightening the puller bolt against the tool plate generates an axial pulling load on the radial reaction puller, resulting in the retraction of the outer seal from the bearing housing.

7. The removal tool assembly of claim 6, further comprising one or more locating pins in the tool plate configured to be installed into corresponding one or more alignment openings in the shaft end for radial and circumferential alignment of the tool plate relative to the radial reaction puller.

8. The removal tool assembly of claim 6, wherein the axial flange in configured to engage with a locating tab of the outer seal.

9. The removal tool assembly of claim 6, wherein the puller bolt is installed into a corresponding threaded puller bolt opening in the radial reaction puller.

10. A removal tool system for a shaft bearing seal including a rotating inner seal element fixed to a rotating shaft and a stationary outer seal fixed to a bearing housing, the removal tool assembly including:
a plurality of seal holders arrayed about a shaft axis of the shaft and configured for engagement with a radially inner surface of the outer seal;
a plurality of radial reaction pullers engaged to the bearing housing;
a plurality of threaded holder rods, each holder rod extending between a seal holder of the plurality of seal holders and a corresponding the radial reaction puller of the plurality of radial reaction pullers;
a plurality of radial pulling nuts installed onto the plurality of holder rods such that tightening the radial pulling nuts onto the holder rods pulls the plurality of seal holders and the outer seal radially outwardly, thus creating a radial gap between the outer seal and the inner seal element;
an axial flange of each radial reaction puller of the plurality of radial reaction pullers configured for engagement with the outer seal;
a tool plate installed to a shaft end of the shaft; and
a plurality of puller bolts extending through the tool plate and engaged to corresponding radial reaction pullers of the plurality of radial reaction pullers;
wherein tightening the plurality of puller bolts against the tool plate generates an axial pulling load on the plurality of radial reaction pullers, resulting in the retraction of the outer seal from the bearing housing.

11. The removal tool system of claim 10, further comprising one or more locating pins in the tool plate configured to be installed into corresponding one or more alignment openings in the shaft end for radial and circumferential alignment of the tool plate relative to the radial reaction puller.

12. The removal tool system of claim 10, wherein the axial flange in configured to engage with a locating tab of the outer seal.

13. The removal tool system of claim 10, wherein the puller bolt is installed into a corresponding threaded puller bolt opening in the radial reaction puller.

14. The removal tool system of claim 10, wherein the shaft is a propeller shaft of a propeller assembly.

15. A method of disassembling a shaft bearing seal assembly including a rotating inner seal element fixed to a rotating shaft and a stationary outer seal fixed to a bearing housing, the method including:
operating a first tool portion, thereby radially moving the outer seal radially outwardly to create a radial gap between the outer seal and the inner seal element; and
operating a second tool portion operably connected to the first tool portion after operating the first tool portion, the operating of the second tool portion axially removing the outer seal from a bearing housing while the inner seal element remains in the bearing housing.

16. The method of claim 15, wherein operating the first tool portion includes:
installing a seal holder to engage with a radially inner surface of the outer seal;
installing a radial reaction puller to engage with the bearing housing;
connecting the seal holder to the radial reaction puller via a threaded holder rod extending between the seal holder and the radial reaction puller; and
tightening a radial pulling nut onto the holder rod such that tightening the radial pulling nut onto the holder rod pulls the seal holder and the outer seal radially outwardly, thus creating the radial gap between the outer seal and the inner seal element.

17. The method of claim 16, wherein operating the second tool portion includes:
engaging an axial flange of the radial reaction puller engaged with the outer seal;
installing a tool plate to a shaft end of the shaft;
connecting the tool plate to the radial reaction puller via a puller bolt extending through the tool plate and into the radial reaction puller; and
tightening the puller bolt against the tool plate, thereby generating an axial pulling load on the radial reaction puller to retract of the outer seal from the bearing housing.

18. The method of claim 17, further comprising installing one or more locating pins of the tool plate configured into corresponding one or more alignment openings in the shaft end to align the tool plate relative to the shaft end.

19. The method of claim 17, wherein the axial flange in configured to engage with a locating tab of the outer seal.

20. The method of claim 17, wherein the puller bolt is installed into a corresponding threaded puller bolt opening in the radial reaction puller.
